(19) United States
(12) Patent Application Publication
(10) Pub. No.: US 2022/0118763 A1
(43) Pub. Date: Apr. 21, 2022

(54) FLUID FEED HOLE

(71) Applicant: Hewlett-Packard Development Company, L.P., Spring, TX (US)

(72) Inventors: Vincent C. Korthuis, Corvallis, OR (US); Stanley Jonathan Wang, Corvallis, OR (US)

(73) Assignee: Hewlett-Packard Development Company, L.P., Spring, TX (US)

(21) Appl. No.: 17/417,819

(22) PCT Filed: Jul. 3, 2019
(86) PCT No.: PCT/US2019/040600

§ 371 Date: Jun. 24, 2021

(51) Int. Cl. B41J 2/16; B41J 2/14; C07F 7/02

(52) U.S. Cl. CPC B41J 2/1626; B41J 2/164; B41J 2202/22; C07F 7/025; B41J 2/14201

(57) ABSTRACT

Example implementations relate to fluid feed holes. For example, a method of forming a fluid feed hole can include forming a via of a threshold size in a plurality of thin films of a fluid ejection die by removing a portion of the plurality of thin films, forming a fluid-attack-resistant material on the plurality of thin films and in the via, planarizing the fluid-attack-resistant material using chemical mechanical planarization (CMP), and forming the fluid feed hole by removing a portion of the planarized fluid-attack-resistant material in the via.

### BACKGROUND

Fluid ejection systems may operate by ejecting a fluid from nozzles to form images on media and/or forming three-dimensional objects, for example. In some fluid ejection systems, fluid feed holes lead fluid into fluid ejection chambers, and the fluid is expelled from nozzles of a fluid ejection die. The fluid may bond to a surface of a medium and form graphics, text, images, and/or objects.

### BRIEF DESCRIPTION OF THE DRAWINGS

FIG. 1A is a diagram of an example fluid ejection die, according to the present disclosure.

FIG. 1B is a diagram of an example cross section of an ejection component of a fluid ejection die, according to the present disclosure.

FIG. 2A is a diagram of a process stage associated with forming a fluid feed hole and/or dummy structure according to the present disclosure.

FIG. 2B is process stage subsequent to that shown in FIG. 2A and associated with forming a fluid feed hole and/or dummy structure according to the present disclosure.

FIG. 20 is process stage subsequent to that shown in FIG. 2B and associated with forming a fluid feed hole and/or dummy structure according to the present disclosure.

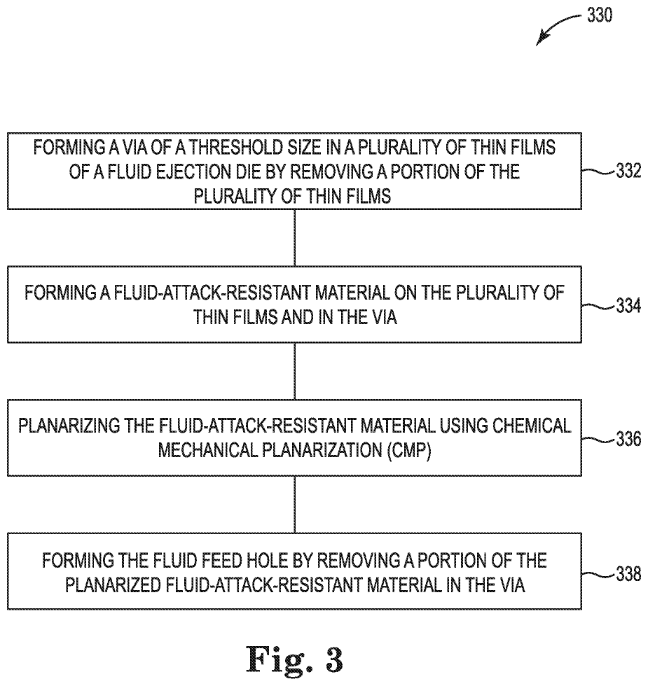

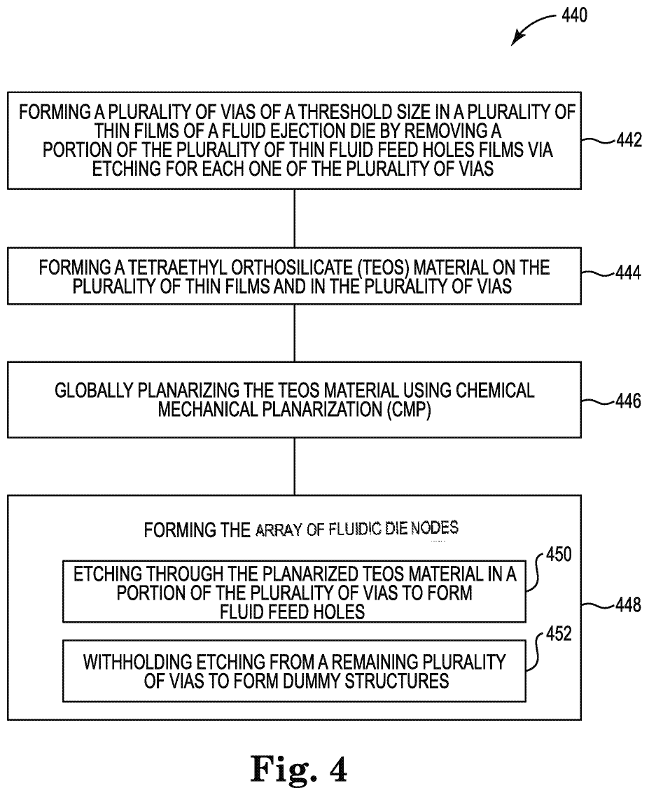

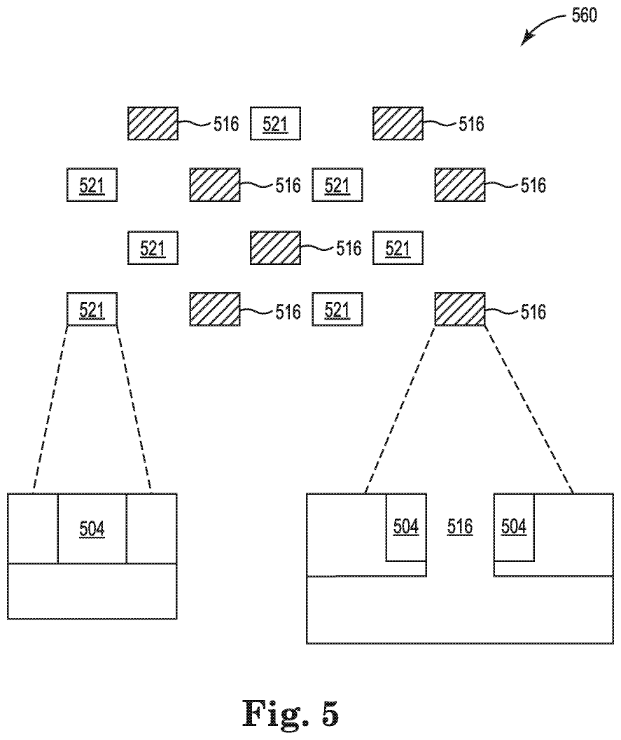

FIG. 2D is process stage subsequent to that shown in FIG. 20 and associated with forming a fluid feed hole and/or dummy structure according to the present disclosure.

FIG. 3 is an example method according to the present disclosure.

FIG. 4 is another example method according to the present disclosure.

FIG. 5 is an example array of fluidic die nodes according to the present disclosure.

### DETAILED DESCRIPTION

Fluid ejection dies may deposit fluids onto media (e.g., a print medium) through a fluid feed hole and a nozzle. For instance, a nozzle can include an opening in a thin film portion of a fluid ejection die, and a fluid feed hole can include a portion of the fluid ejection die through which the fluid passes before reaching the nozzle and the media. Some fluid ejection dies have large architectural areas of thin films into which fluid feed holes are formed. These thin films may be susceptible to fluid attack when a fluid contacts the thin films. For instance, boron/phosphorus doped silica glass (BPSG) and/or other poly films may be attacked or etched by fluid if the fluid passes through the thin film (e.g., during a printing process). This can result in degradation or reduced life of fluid ejection dies. For instance, a resistor of the fluid ejection day may be damaged, resulting in an ejection component being unable to fire. Additionally or alternatively, fluid attack of the thin film may result in undercut or voided areas where fluid may cause shorting of circuits.

In contrast, some examples of the present disclosure include protecting thin films from fluid attack using a fluid-attack-resistant material that is formed on the thin films and planarized during a fluid feed hole creation process. For instance, some examples include forming a fluid-attack-resistant material such as tetraethyl orthosilicate (TEOS) and/or a thermal oxide on the thin films and in vias formed in the thin films. The fluid-attack-resistant material may be planarized and subsequently etched, resulting in a fluid feed hole with fluid-attack-resistant sidewalls. A “fluid-attack-resistant material” as used herein, includes a material that is resistant to chemical or other attacks, such as an undesirable material etch, by fluids passing through a fluid ejection die (e.g., fluidic dies, printheads, or other types of apparatuses that may include fluid feed holes through deposited thin films).

The large architectural areas of thin films on some fluid ejection dies can hinder or prevent desired planarization processes. For instance, a fluid ejection die undergoing planarization in a fluid feed hole or dummy structure creation process may experience non-uniform or inconsistent planarization due to existing uneven pattern density of the thin films that is a side effect of the large architectural area. Planarization, for instance, may be desired to smooth a fluid ejection die's surface for preparation and creation of a fluid feed hole or dummy structure for use in an array of fluidic die nodes of the fluid ejection die. Planarization may also be desired when materials that cannot be polished using other methods (e.g., chemical etching, free abrasive polishing, etc.) are used in fluid ejection die fabrication due to size or material make-up. Non-uniform and/or inconsistent planarization may result in incomplete and/or inefficient creation of fluid feed holes and/or dummy structures in the fluid ejection die.

In contrast, some examples of the present disclosure can include smaller architectural areas of those thin films (e.g., as opposed to one large area) that allows for substantially uniform global planarization (e.g., chemical mechanical planarization (CMP)) of the fluid-attack-resistant material. As used herein, “substantially” means that a characteristic (e.g., uniformity) need not be absolute, but is close enough to the absolute characteristic so as to achieve the desired effects of the characteristic.) For instance substantially uniform global planarization means a surface of the fluid ejection die is mostly consistent following planarization but may include inconsistencies below a threshold.

Additionally, a number of dummy structures may make up an array of fluidic die nodes (e.g., along with nodes into which fluid feed holes will be formed) and may facilitate uniform planarization. For example, even though a die may not support a number of nozzles at a pitch of X units (e.g., such as due to fabrication and structural constraints), an increased density of nodes in an array of fluidic die nodes may be achieved by grouping nodes for both fluid feed holes and dummy structures. Such an increased density of nodes may be desirable in order to provide increased uniformity of planarization (such as compared with an implementation in which node density is comparatively lower).

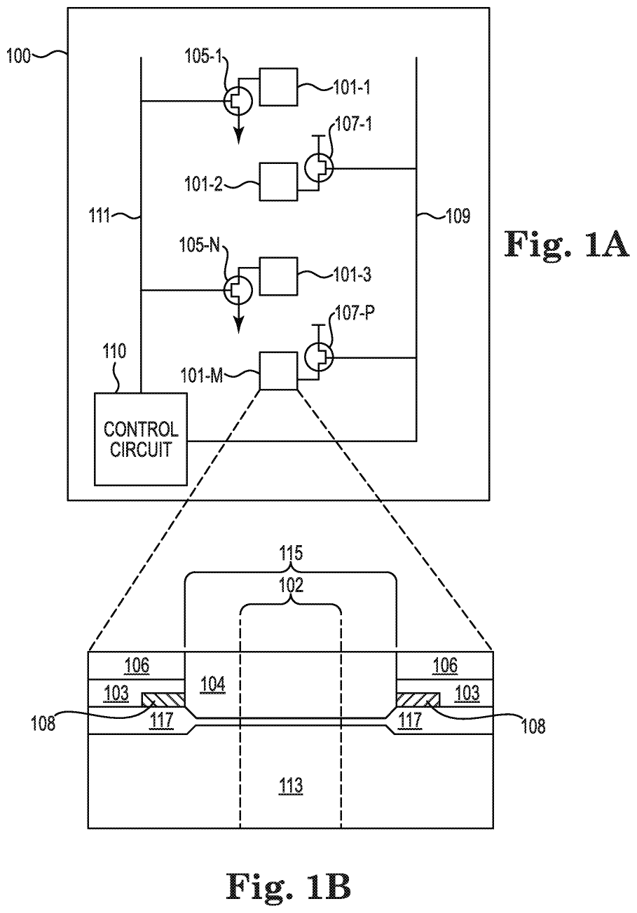

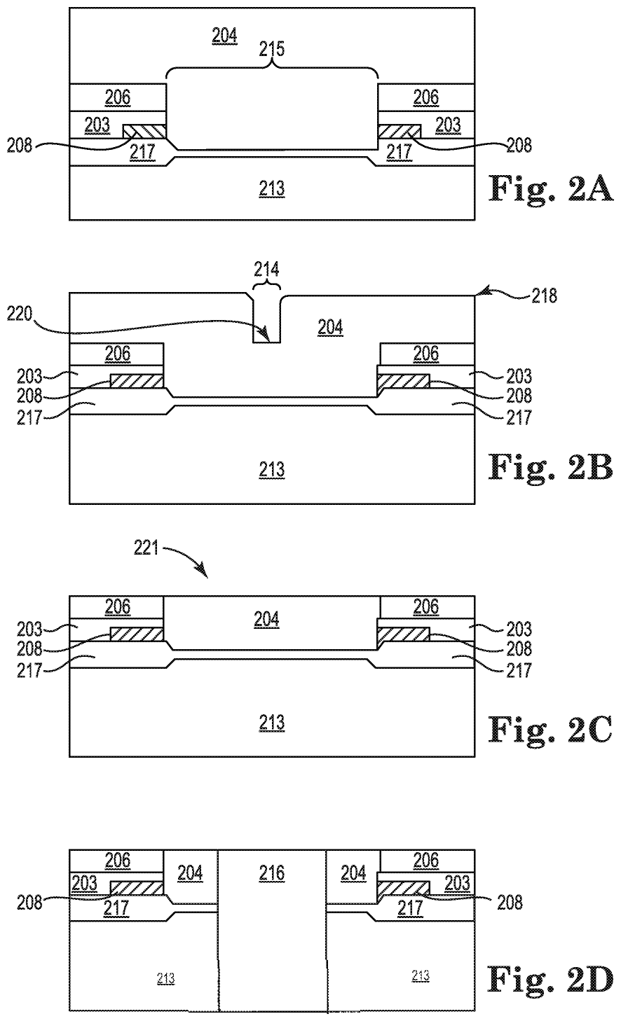

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. Multiple analogous elements within one figure may be referenced with a reference numeral followed by a hyphen and another numeral or a letter. For example, 101-1 may reference element 01-1 in FIGS. 1 and 101-2 may reference element 01-2, which can be analogous to element 01-1. Such analogous elements may be generally referenced without the hyphen and extra numeral or letter. For example, elements 101-1 and 101-2 may be generally referenced as 101.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “M”, “N”, “P”, “R”, and “T” particularly with respect to reference numerals in the drawings, indicates that a number of the particular feature so designated can be included with examples of the present disclosure. The designators can represent the same or different numbers of the particular features.

FIG. 1A illustrates a diagram of an example fluid ejection die 100, according to the present disclosure. As illustrated in FIG. 1A, fluid ejection die 100 may include a plurality of ejection components 101-1, 101-2, 101-3 . . . 101-M (referred to collectively as ejection components 101). FIG. 1B illustrates a diagram of a cross section of the ejection component (e.g., a fluid feed portion of the fluid ejection die 100) 101-M. For instance, FIG. 1B illustrates how a fluid may enter fluid chambers (not illustrated here) where within the fluid chambers is an ejection device (e.g., a resistor) that ejects fluid through a nozzle.

Referring to FIG. 1A, a top view of the fluid ejection die 100 is illustrated in the X and Y axes, while a cross section of the ejection component 101-M is illustrated in the X and Z axes in FIG. 1B. While a cross section is illustrated fora fluid feed portion of the ejection component 101-M, it is to be understood that the same cross section may be illustrated for the ejection components 101-1, 101-2, and 101-3. The ejection component 101-M may include a substrate material 113 (e.g., a silicon substrate material), a thermally grown oxide material 117 (e.g., a field oxide material), and thin film materials 108, 103, and 106 formed thereon. For instance, the thin film materials 108, 103, and 106 may include a poly silicon material, a doped silica glass, and a BPSG, respectively. More, fewer, and/or different thin films may be present. In some examples, a fluid-attack-resistant material 104 such as a TEOS and/or a thermal oxide material is formed in a via 115 etched into the thin film materials 108, 103, and 106. The area 102, as will be described further herein, represents a potential fluid feed hole location or potential area for coupling to a control line or an interconnect. For instance, if the area 102 is removed, it results in a fluid feed hole. A dummy structure results if the area 102 is not removed. In some instances, the area 102 may be formed in different thicknesses of the thermally grown oxide material 117 (e.g., thin vs. thick portions).

Ejection component 101-M may include additional components, such as additional or different metals, metal oxides, dielectrics, and/or other materials for instance. Although not illustrated in FIG. 1B, each ejection component may include an energized component to eject fluid through a nozzle.

Each ejection component among the plurality of ejection components 101 may be electrically coupled to a first control line 111 by a respective switch 105-1, 105-N (collectively referred to herein as switches 105) among a first group of switches, or a second control line 109 by a respective switch 107-1, 107-P (collectively referred to herein as switches 107) among a second group of switches. In some examples, the first group of switches 105 may be of a different type than the second group of switches 107. For instance, the switches 105 may be N-type switches, whereas switches 107 may be P-type switches. That is, ejection components 101-1 and 101-3 may be electrically coupled to the second control line 111 by P-type switches 105-1 and 105-N, respectively, and ejection components 101-2 and 101-M may be electrically coupled to the first control line 109 by P-type switches 107-1 and 107-P, respectively. As used herein, an N-type switch refers to a device capable of amplifying and/or switching electronic signals using an N-type semiconductor. Examples of an N-type switch may include an N-type field-effect transistor (FET) and/or an N-type metal-oxide-semiconductor field-effect transistor (MOSFET). Examples are not so limited, however, and the plurality of ejection components may be coupled to the control line in other ways. As used herein, a P-type switch refers to a device capable of amplifying and/or switching electronic signals using a P-type semiconductor. Examples of a P-type switch may include a P-type FET and/or a P-type MOSFET. Although switches 107 and 105 are illustrated as P-type switches and N-type switches, respectively, examples are not so limited. For example, switches 107 may be N-type switches and switches 105 may be P-type switches. In another example, switches 107 and 105 may be other types of switches, arranged such that an alternating bias is generated among the ejection components 101.

Referring again to FIG. 1A, each respective switch of the first group of switches 105 may include a first side electrically coupled to the respective ejection component, and a second side electrically coupled to a low bias voltage. For example, a first side of switch 105-1 may be electrically coupled to ejection component 101-1, and a second side of switch 105-1 may be electrically coupled to a low bias voltage, such as ground, or a 1V power supply, among other examples. A gate of switch 105-1 may be electrically coupled to control line 111. Similarly, each respective switch of the second group of switches 107 may include a first side electrically coupled to a supply voltage, and a second side electrically coupled to the respective ejection component. That is, the fluid ejection die 100 may include a gate of each respective switch of the first group of switches 105 electrically coupled to the first control line 111, and a gate of each respective switch of the second group of switches 107 electrically coupled to the second control line 109.

Fluid ejection die 100 may further include a control circuit 110 to generate an alternating bias among the plurality of ejection components 101 using a plurality of control lines. That is, the control circuit 110 may create an alternating bias among the plurality of ejection components using the first control line 111 and the second control line 109.

FIG. 2A is a diagram of a process stage associated with forming a fluid feed hole 216 and/or dummy structure 221 according to the present disclosure. Elements identified in FIG. 2A may be present and labeled as such in FIGS. 2B, 2C, and/or 2D and vice versa. Thin film materials 208, 203, and 206 are formed on a substrate 213 and a thermally grown oxide material 217 of a fluid ejection die. A via 215 is formed by removal of a portion of thin film materials 208, 203, and 206. The via 215, for instance, may be etched using one of a plurality of etching approaches (e.g., dry etch, chemical etch, physical etch, combination etch, etc.). The thin film materials 208, 203, and 208 may be susceptible to fluid attacks such that they are etched and/or degraded by the fluid. For example, a thin film may be fluid-attack-susceptible when a fluid (e.g., an ink having a high pH value) passes through or contacts the thin film, causing the thin films to be attacked and etched away.

Subsequent to the removal of the portion of the thin film materials 208, 203, and 206, a fluid-attack-resistant material 204 can be formed in contact with the thin film materials 208, 203, and 206. For instance, the fluid-attack-resistant material 204 is formed on a top surface of thin film material 206 and in the via 215, resulting in coverage of sidewalls of the thin film materials 208, 203, and 206.

FIG. 2B is process stage subsequent to that shown in FIG. 2A and associated with forming a fluid feed hole 216 (see, FIG. 2D) and/or dummy structure 221 according to the present disclosure. Subsequent to formation of the fluid-attack-resistant material 204, a seam 214 (also called a “pinhole”) may be formed in the fluid-attack-resistant material 204, for instance during formation of the fluid-attack-resistant material 204 within the via 215. The seam 214 may not be formed by removal of material, but instead may be formed in the material 204 due to the geometry of the via 215. For instance, the wider the via 215, the wider the seam 214. Formation of the seam 214 can facilitate a faster planarization rate at the top surface 218 of the fluid-attack-resistant material 204, while a planarization rate near the bottom surface 220 of seam 214 may be substantially slower. As used herein, a planarization rate refers to a speed at which materials (e.g., thin film materials) are removed or flattened during the planarization process. A faster planarization rate can result in an increase in efficiency of fluid ejection die fabrication.

For a seam having a large width (e.g., 30 microns or greater), the planarization process may remove a portion of the fluid-attack-resistant material 204 within the via 215 at approximately a same rate as a portion of the fluid-attack-resistant material 204 is removed above the thin film material 206. This may be undesirable because a resulting layer of the fluid-attack-resistant material 204 may be uneven and may provide less protection (e.g., against printing fluid etch). In contrast, if the seam 214 is narrower (e.g., less than 30 microns wide),material removal at the bottom surface 220 may be slowed, which can prevent uneven planarization. Put another way, the small width can allow for a substantially uniform global planarization of the fluid-attack-resistant material 204. For instance, planarization may include the top surface 218 being removed uniformly with little to no removal of the bottom surface 220 of the seam 214.

FIG. 2C is process stage subsequent to that shown in FIG. 2B and associated with forming a fluid feed hole 216 and/or dummy structure 221 according to the present disclosure. Subsequent to formation of the seam 214, a planarization (e.g., CMP) process can be performed, such that substantially uniform global planarization of the fluid-attack-resistant material 204 occurs. Put another way, global planarization is achieved when planarization results in a substantially flat surface (e.g., flat surface including top of thin film 206 and planarized fluid-attack-resistant material 204). The planarization results in a dummy structure 221 that may be present in an array of fluidic die nodes and can be coupled to a control line or interconnect, in some examples. For instance, circuitry may be present on the substrate material 213 or an interconnect may be coupled to the dummy structure 221, among other control line and interconnect couplings to the dummy structure 221.

FIG. 2D is process stage subsequent to that shown in FIG. 2C and associated with forming a fluid feed hole 216 and/or dummy structure 221 according to the present disclosure. After the planarization, a fluid feed hole 216 can be formed in the fluid-attack-resistant material 204 by removing a portion of the fluid-attack-resistant material 204 (e.g., via an etch). In some examples, more than one fluid feed hole can be formed in the via 215. In some examples, substrate material 213 may be etched to include a continuous ink channel from the back of the fluid ejection die to a top surface of the thin films for ejection.

FIG. 3 is an example method 330 according to the present disclosure. The method 330 can include, in some examples, a method of forming a fluid feed hole. For instance, at 332, the method 330 can include forming a via of a threshold size in a plurality of thin films of a fluid ejection die by removing a portion of the plurality of thin films. The via, for instance, may be 50 microns wide and may be formed by removing the portion of the plurality of thin films such that the portion of the plurality of thin films is less than 50 microns wide.

At 334, the method 330 can include forming a fluid-attack-resistant material such as TEOS and/or a thermal oxide on the plurality of thin films and in the via. Put another way, the via of less than 50 microns may be formed in the thin films and filled with the fluid-attack-resistant material. In some examples, a seam is formed in the fluid-attack-resistant material during formation of the fluid-attack-resistant material such that the seam is less than 30 microns wide. The seam of less than 30 microns is formed in the fluid-attack-resistant material such that on either side of the seam is less than 10 microns of fluid-attack-resistant material (e.g., 30-micron seam with 10 microns of TEOS on each side). While 50 microns, 30 microns, and 10 microns are used herein, other dimensions may be possible.

The method 330, at 336, can include planariz ng the fluid-attack-resistant material using CMP, as noted above. Because of the substantially uniform pattern density of the vias (e.g., of a threshold size) and the seams, global planarization across a fluid ejection die may be achieved (e.g., a substantially flat surface is achieved). At 338, the method 330 can include forming the fluid feed hole by removing a portion of the planarized fluid-attack-resistant material in the via. For instance, by etching through the fluid-attack-resistant material to a substrate material, a fluid feed hole can be created resulting in a path to a resistor. In some examples, the method 330 can include forming a dummy structure in a different portion of the planarized fluid-attack-resistant material in the via by withholding etching through the different portion. For instance, a different portion can include another location within the planarized fluid-attack-resistant material that was formed in the via.

In some examples, the method 330 can include continuing to form and etch additional thin films following the planarizing and protecting of the susceptible thin films (e.g., using a deposition/photo/etch process), as discussed in relation to 332-338, such as to form a fluid ejection die comprising ejection chambers in fluid communication with the through holes formed at 338. Thus, in some cases, method 330 may include additional layers and/or etches.

FIG. 4 is another example method 440 according to the present disclosure. The method 440 can include a method of forming an array of fluidic die nodes. For instance, at 442, the method 440 can include forming a plurality of vias of a threshold size in a plurality of thin films of a fluid ejection die ejection component by removing a portion of the plurality of thin films via etching for each one of the plurality of vias. At 444, the method 440 can include forming a TEOS material on the plurality of thin films and in the plurality of vias. A seam may be formed in the TEOS material to further improve subsequent planarization processes.

For instance, the method 440, at 446, can include globally planarizing the TEOS material using CMP. The global planarization, in some examples can include planarizing a base of each one of the plurality of seams subsequent to planarizing the TEOS formed on the plurality of thin films. For instance, CMP is more efficient with substantially uniform planarization (e.g., global planarization). A smaller seam (due to a smaller via) results in a more uniform planarization rate across a fluid ejection die.

At 448, the method 440 can include forming the array of fluidic die nodes, which includes fluid feed holes and dummy structures. Forming the array of fluidic die nodes can include, for instance as shown at 450, etching through the planarized TEOS material in a portion of the plurality of vias to form fluid feed holes. Forming the array of fluidic die nodes, as shown at 452, can also include withholding etching from a remaining plurality of vias to form dummy structures. For example, withholding etching from a remaining plurality of vias may be accomplished by applying a protective layer, such as a photoresist, over the vias in one case. In some examples, the array of fluidic die nodes is formed in a pattern of fluid feed holes and dummy structures. For instance, the pattern may include a threshold percentage (e.g., 50 to 90 percent) of dummy structures and/or may be determined based on a desired dots-per-inch measure of a printing device and/or fluid ejection device associated with the fluid ejection die. For example, nozzles may be fluidly coupled to the fluid feed holes of the array of fluidic die nodes such that fluid is ejected through the nozzles in compliance with the desired dots-per-inch measure. In some instances, the pattern may be determined based on a pattern density (e.g., the threshold percentage) that results in substantially global planarization.

FIG. 5 is an example array of fluidic die nodes 560 according to the present disclosure. The array of fluidic die nodes 560 can include a pattern of fluid feed holes 516 and dummy structures 521 (e.g., a 50 percent pattern illustrated in FIG. 5). Each of the fluid feed holes 516 can include silicon oxide thin film sidewalls insulated from fluid attack by a fluid-attack resistant material 504 such as TEOS and/or a thermal oxide material, For instance, the silicon oxide thin film sidewalls protect thin films such as BPSG and/or polysilicon from fluid attack (e.g., chemical attack). In some examples, one of the fluid feed holes 516 facilitates transportation of fluid to a resistor or other fluid ejector such as a piezoelectric membrane of a fluid ejection die. In some examples, the array of fluidic die nodes 560 feeds a fluid ejection die nozzle.

The dummy structures 521, in some examples, are electrically coupled to a control line or an interconnect. The dummy structures 521 can make up a threshold percentage of the array of fluidic die nodes 560. For example, the threshold percentage of the dummy structures can be between 50 and 90 percent of the array of fluidic die nodes 560. This threshold percentage and/or the pattern of the fluid feed holes 516 may be based on a desired dots-per-inch measure, in some examples. For instance, while the dummy structures 521 and fluid feed holes 516 in FIG. 5 are illustrated in an “every other” pattern with a dummy structure percentage of 50, a different pattern including a different percentage of dummy structures 521 may be used,

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method of forming a fluid feed hole, comprising:
forming a via of a threshold size in a plurality of thin films of a fluid ejection die by removing a portion of the plurality of thin films;
forming a fluid-attack-resistant material on the plurality of thin films and in the via;
planarizing the fluid-attack-resistant material using chemical mechanical planarization (CIMP); and
forming the fluid feed hole by removing a portion of the planarized fluid-attack-resistant material in the via.

2. The method of claim 1, further comprising forming a dummy structure in a different portion of the planarized fluid-attack-resistant material in a different via by withholding etching through the different portion.

3. The method of claim 1, wherein forming the fluid-attack-resistant material on the plurality of thin films and in the via comprises forming a tetraethyl orthosilicate (TEOS) material on the plurality of thin films and in the via.

4. The method of claim 1, wherein forming the fluid-attack-resistant material on the plurality of thin films and in the via comprises forming a thermal oxide material on the plurality of thin films and in the via.

5. The method of claim 1, further comprising forming a seam in the fluid-attack-resistant material prior to the planarizing such that the seam is less than 30 microns wide.

6. An array of fluidic die nodes, comprising:
a pattern of fluid feed holes and dummy structures, comprising:
a plurality of fluid feed holes, each one of the plurality of fluid feed holes comprising silicon oxide thin film sidewalls insulated from fluid attack by a fluid-attack-resistant material; and
a plurality of dummy structures comprising a threshold percentage of the array of fluidic die nodes.

7. The array of fluidic die nodes of claim 6, further comprising the plurality of dummy structures electrically coupled to a control line.

8. The array of fluidic die nodes of claim 6, further comprising the plurality of dummy structures coupled to an interconnect.

9. The array of fluidic die nodes of claim 6, wherein the pattern is based on a desired dots-per-inch measure.

10. The array of fluidic die nodes of claim 6, wherein the threshold percentage comprises between 50 and 90 percent of the array of fluidic die nodes.

11. The array of fluidic die nodes of claim 6, wherein one of the plurality of fluid feed holes facilitates transportation of fluid to a resistor of a fluid ejection die.

12. The array of fluidic die nodes of claim 6, wherein the array of fluidic die nodes feeds a fluid ejection die nozzle.

13. A method of forming an array of fluidic die nodes, comprising:
forming a plurality of vias of a threshold size in a plurality of thin films of a fluid ejection die nozzle by removing a portion of the plurality of thin films via etching for each one of the plurality of vias;
forming a tetraethyl orthosilicate (TEOS) material on the plurality of thin films and in the plurality of vias;
globally planarizing the TEOS material using chemical mechanical planarization (CMP); and
forming the array of fluidic die nodes by:
etching through the planarized TEOS material in a portion of the plurality of vias to form fluid feed holes; and
withholding etching from a remaining plurality of vias to form dummy structures.

14. The method of claim 13, further comprising forming the array of fluidic die nodes in a pattern of fluid feed holes and dummy structures.

15. The method of claim 13, further comprising forming a seam in the TEOS material in each one of the plurality of vias prior to global planarization, wherein globally planarizing the TEOS comprises planarizing a base of each one of the seams subsequent to planarizing the TEOS formed on the plurality of thin films.
